(19) United States
(12) Patent Application Publication
(10) Pub. No.: US 2019/0278903 A1
(43) Pub. Date: Sep. 12, 2019

(54) VEHICLE CONTROL MODULE SECURITY CREDENTIAL REPLACEMENT

(71) Applicant: GM GLOBAL TECHNOLOGY OPERATIONS LLC, Detroit, MI (US)

(72) Inventors: Yuval Polevoy, West Bloomfield, MI (US); David W. Racklyeft, Troy, MI (US); John D. Dobbs, Farmington Hills, MI (US)

(21) Appl. No.: 15/913,108

(22) Filed: Mar. 6, 2018

(51) Int. Cl. G06F 21/45; H04L 29/06; H04L 9/32; H04L 9/30

(52) U.S. Cl. CPC G06F 21/45; H04L 63/10; H04L 9/3297; H04L 9/3247; H04L 9/30; H04L 63/108

(57) ABSTRACT

Examples of techniques for replacing a security credential in a vehicle control module are disclosed. In one example implementation according to aspects of the present disclosure, a method includes authorizing, by a management system, a service system to replace the security credential of the vehicle control module. The method further includes initiating, by the service system, a replace security credential command to replace the security credential in the vehicle control module. The method further includes verifying, by the vehicle control module, the replace security credential command. The method further includes initiating, by the vehicle control module, a replace security credential request. The method further includes verifying, by the management system, the replace security credential request. The method further includes creating, by the management system, a new security credential for the vehicle control module. The method further includes installing, by the vehicle control module, the new security credential.

### INTRODUCTION

The present disclosure relates generally to vehicle systems and more particularly to replacing a security credential in a vehicle control module.

Vehicle control modules are electronic modules that control various aspects of vehicles. For example, a vehicle control module can control a vehicle's engine, communication, steering, navigation, infotainment, and other systems. In one example, a vehicle control module can control vehicle-to-vehicle (V2V) communications where a first vehicle transmits data to a second vehicle. The vehicle control module can also control other communication interfaces such as vehicle-to-infrastructure (V2I), vehicle-to-everything (V2X), vehicle-to-pedestrian (V2P), vehicle-to-device (V2D), and the like.

### SUMMARY

In one exemplary embodiment, a computer-implemented method for replacing a security credential in a vehicle control module includes authorizing, by a processing device of a management system, a service system to replace the security credential of the vehicle control module. The method further includes initiating, by a processing device of the service system, a replace security credential command to replace the security credential in the vehicle control module. The method further includes verifying, by a processing device of the vehicle control module, the replace security credential command. The method further includes initiating, by the processing device of the vehicle control module, a replace security credential request. The method further includes verifying, by the processing device of the management system, the replace security credential request. The method further includes creating, by the processing device of the management system, a new security credential for the vehicle control module. The method further includes installing, by the processing device of the vehicle control module, the new security credential.

In some examples, the authorizing includes creating, by the processing device of the service system, a request for service authorization; authenticating, by the processing device of the management system, the request for service authorization; and issuing, by the processing device of the management system, a service authorization token to the service system. In some examples, the request for service authorization includes: a service system identifier of the service system, a vehicle identifier of a vehicle associated with the vehicle control module, a vehicle control module identifier, a public key of the vehicle control module, and a timestamp signed by the corresponding private key of the vehicle control module. In some examples, the service authorization token includes an identifier of the service system that is authorized to perform the replacement, a public key of the vehicle control module whose security credential the service system is authorized to replace, a time window during which the service system is authorized to perform the replacement, and a digital signature over the authorization token created by a private key of the management system. In some examples, the time window includes a start time and an end time. In some examples, the service system sending to the vehicle control module a replace security credential command to replace the security credential in the vehicle control module includes the service system sending to the vehicle control module an authorization token, a service system identifier, and a replace security credential command. In some examples, an old security credential is revoked prior to the new security credential being created.

In another exemplary embodiment, a system includes a memory including computer readable instructions and a processing device for executing the computer readable instructions for performing a method for replacing a security credential in a vehicle control module. In examples, the method includes authorizing, by a management system, a service system to replace the security credential of the vehicle control module. The method further includes initiating, by the service system, a replace security credential command to replace the security credential in the vehicle control module. The method further includes verifying, by the vehicle control module, the replace security credential command. The method further includes initiating, by the vehicle control module, a replace security credential request. The method further includes verifying, by the management system, the replace security credential request. The method further includes creating, by the management system, a new security credential for the vehicle control module. The method further includes installing, by the vehicle control module, the new security credential.

In some examples, the authorizing includes creating, by the service system, a request for service authorization; authenticating, by the management system, the request for service authorization; and issuing, by the management system, a service authorization token to the service system. In some examples, the request for service authorization includes: a service system identifier of the service system, a vehicle identifier of a vehicle associated with the vehicle control module, a vehicle control module identifier, a public key of the vehicle control module, and a timestamp signed by the corresponding private key of the vehicle control module. In some examples, the service authorization token includes an identifier of the service system that is authorized to perform the replacement, a public key of the vehicle control module whose security credential the service system is authorized to replace, a time window during which the service system is authorized to perform the replacement, and a digital signature over the authorization token created by a private key of the management system. In some examples, the time window includes a start time and an end time. In some examples, the service system sending to the vehicle control module a replace security credential command to replace the security credential in the vehicle control module includes the service system sending to the vehicle control module an authorization token, a service system identifier, and a replace security credential command. In some examples, an old security credential is revoked prior to the new security credential being created. In some examples, the vehicle control module sending to the management system a security credential request includes the vehicle control module sending to the management system a security credential request command, a service authorization token from the service system, a public key of the vehicle control module, and a timestamp signed by a private key of the vehicle control module

In yet another exemplary embodiment a computer program product includes a computer readable storage medium having program instructions embodied therewith, wherein the computer readable storage medium is not a transitory signal per se, the program instructions executable by a processing device to cause the processing device to perform a method for replacing a security credential in a vehicle control module. In examples, the method includes authorizing, by a management system, a service system to replace the security credential of the vehicle control module. The method further includes initiating, by the service system, a replace security credential command to replace the security credential in the vehicle control module. The method further includes verifying, by the vehicle control module, the replace security credential command. The method further includes initiating, by the vehicle control module, a replace security credential request. The method further includes verifying, by the management system, the replace security credential request. The method further includes creating, by the management system, a new security credential for the vehicle control module. The method further includes installing, by the vehicle control module, the new security credential.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a block diagram of a system for replacing a security credential in a vehicle control module, according to aspects of the present disclosure;

FIG. 2A depicts a flow diagram of an authorization method to authorize a service system to replace a security credential in the vehicle control module, according to aspects of the present disclosure;

FIG. 2B depicts a flow diagram of a replacement method to replace the security credential in the vehicle control module, according to aspects of the present disclosure;

FIG. 3 depicts a flow diagram of a method for replacing a security credential in a vehicle control module, according to aspects of the present disclosure; and

FIG. 4 depicts a block diagram of a processing system for implementing the techniques described herein, according to aspects of the present disclosure.

The above features and advantages, and other features and advantages of the disclosure are readily apparent from the following detailed description when taken in connection with the accompanying drawings.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

A vehicle control module (VCM) creates a unique module authorization key (MAK) private/public key pair, which acts as a security identifier for the VCM. In the secure context of the VCM manufacturing process, the VCM's MAK is used to authenticate a request for the VCM's first security credential from a management system. The management system registers the association of the VCM's MAK public key with the VCM's security credential. In the secure context of the vehicle assembly process, a VCM identifier (VCMID) is associated with the vehicle identifier. The management system registers authorized service tool identifiers and defines a minimum time between security credential replacements to restrict how frequently a VCM can receive a replacement security credential. This value is typically greater than the time it takes to communicate the revocation of a security credential to all vehicles in the security domain of trust maintained by the management system.

The technical solutions described herein provide for replacing a security credential in a vehicle control module. From time to time, such as prior to (or after) the expiration of a security credential in a VCM, it may be desirable to replace the security credential with a new security credential. The present techniques facilitate such replacement through the use of a combination of multiple, independent registrations/authentications for securing a service event. These can include a service system ID registration with a management system, a VCMID registration with a vehicle ID, and a VCM's MAK with a VCM security credential. The management system verifies the service system ID, VCMID, vehicle ID, the VCM's MAK public key, and the VCM's possession of the MAK private key in order to issue a token authorizing the service system to instruct the VCM to replace its security credential. In addition, the present techniques provide a process that can be securely executed through combining the use of time-bound service authorization tokens, the use of the MAK private key-signed replace security credential request, a minimum time between security credential replacement threshold, and the revocation of the replaced security credential. Accordingly, a security credential for a VCM can be replaced securely without the need for human involvement and/or physical proximity.

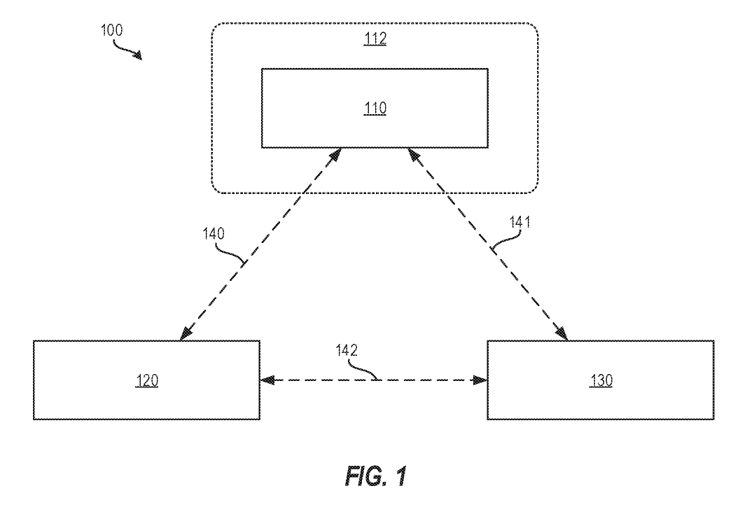

FIG. 1 depicts a block diagram of a system 100 for replacing a security credential in a vehicle control module (VCM) 110 in a vehicle 112, according to aspects of the present disclosure. The system 100 includes the following components: the VCM 110, a service system 120, and a management system 130.

The various components, modules, engines, etc. described regarding FIG. 1 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the components described herein can be a combination of hardware and programming. For example, each of the components can include a processing device and a memory. The programming can be processor executable instructions stored on a tangible memory, and the hardware can include a processing device for executing those instructions. Thus a system memory can store program instructions that when executed by the processing device implement the functionality described herein. Other components, modules, engines, etc. can also be utilized to include other features and functionality described in other examples herein.

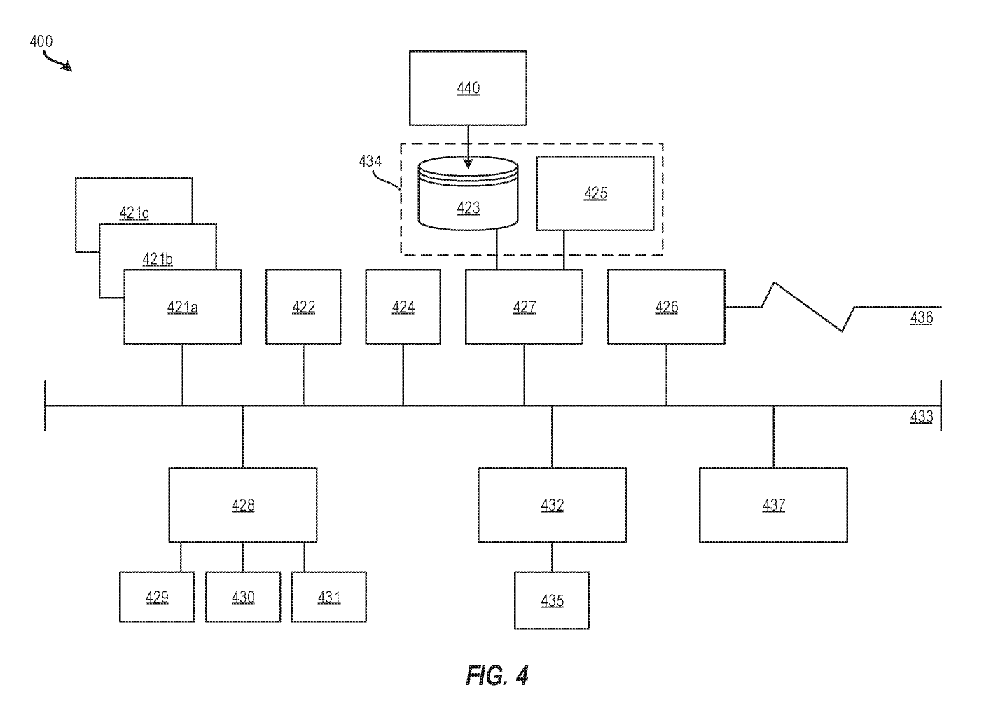

Each of the VCM 110, the service system 120, and the management system 130 are in communication with one another: the VCM 110 and the service system 120 are in communication via communication link 140, the VCM 110 and the management system 130 are in communication via communication link 141, and the service system 120 and the management system 130 are in communication via communication link 142. It should be appreciated that each of the VCM 110, the service system 120, and the management system 130 can include a network adapter (e.g., the network adapter 426 of FIG. 4) to enable the components to transmit and receive data, such as via the communication links 140-142. The communication links 140-142 can be one or more of a wired and/or wireless communication link between the components. In some examples, additional devices, such as routers, switches, hubs, etc., can be used to facilitate communication between the components over the communication links 140-142.

In one or more embodiments, one or more of the components of the system 100 can be implemented on the processing system 400 depicted in FIG. 4. Additionally, a cloud computing system can be in wired or wireless electronic communication with one or all of the components of the system 100. Cloud computing can supplement, support or replace some or all of the functionality of the elements of the system 100. Additionally, some or all of the functionality of the components of the system 100 can be implemented as a node of a cloud computing system. A cloud computing node is only one example of a suitable cloud computing node and is not intended to suggest any limitation as to the scope of use or functionality of embodiments described herein.

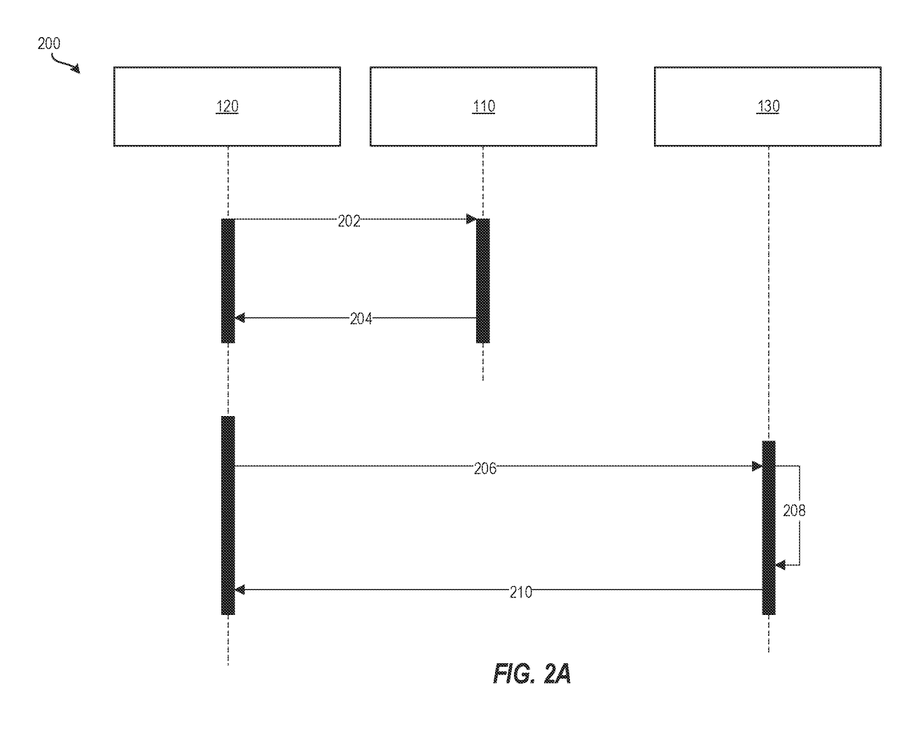

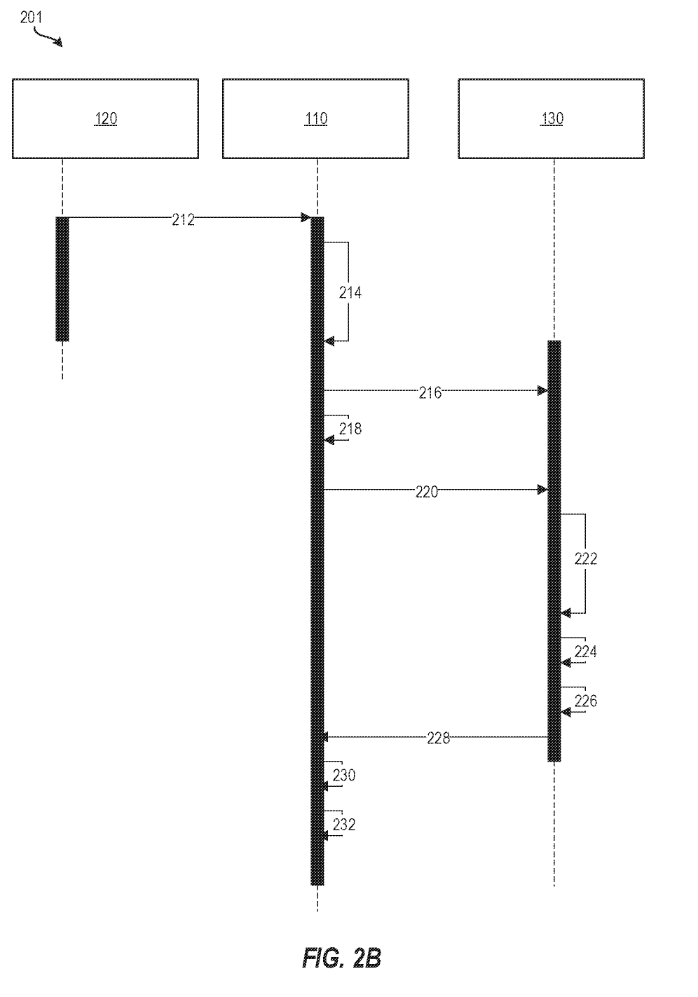

It may be desirable to replace a security credential of the VCM 110, such as when the security credential is about to expire or has expired. To replace the security credential of the VCM 110, the following procedure occurs and includes an authorization method 200, FIG. 2A, to authorize the service system 120 to replace a security credential in the VCM 110 and a replacement method 201, FIG. 2B, to replace the security credential in the VCM 110.

FIG. 2A depicts a flow diagram of an authorization method 200 to authorize the service system 120 to replace a security credential in the VCM 110, according to aspects of the present disclosure. At 202, the service system 120 creates a request for service authorization by collecting and assembling information for the service event. At 204, such information is received from the VCM 110 and can include the vehicle ID of the vehicle 112, the VCMID of the VCM 110, the MAK public key of the VCM 110, and/or a timestamp signed by the MAK private key of the VCM 110. At 206, the service system 120 adds its service system ID to the VCM information received from 204 and sends the request for service authorization to the management system 130 via the communication link 142.

At 208, the management system 130 authenticates the received request for service authorization to authorize the service system 120 to be used to replace the security credential of the VCM 110. Such authentication occurs when one or more of the following are true: the service system ID is registered to the management system 130, the VCMID is registered to the vehicle ID for the vehicle 112 in the management system 130, the signature on the timestamp is validated by the MAK public key of the VCM 110, the current time is proximate to the timestamp (e.g., within a certain period of time, such as 45 seconds, 2 minutes, 15 minutes, etc.), the MAK public key is registered to a security credential in the management system 130, and/or the current time minus the time when the management system 130 last issued a security credential for the VCM 110 is greater than a minimum time between security credential replacement threshold. In some embodiments, each of these conditions must be met before the management system 130 authorizes the service system 120 to be used to replace the security credential of the VCM 110.

Once the management system 130 authenticates the received request for service authorization, at 210, the management system 130 issues a service authorization token to the service system 120 via the communication link 142. The service authorization token (“token”) can include the following information: the ID of the service system 120 that is authorized to perform the replacement, the MAK public key of the VCM 110 whose security credential the service system 120 is authorized to replace, a time window (e.g., start time and end time) during which the service system 120 is authorized to perform the replacement, and/or a digital signature over the token created by a private key of the management system 130. This completes the authorization method 200, at which point the security credential can be replaced in the VCM 110, as described with reference to FIG. 2B.

In particular, FIG. 2B depicts a flow diagram of a replacement method 201 to replace the security credential in the VCM 110, according to aspects of the present disclosure. At 212, the service system 120 sends its service authorization token, service system ID, and a “replace security credential” command to the VCM 110. At 214, the VCM 110 executes this command if one or more of the following are true: the service system ID in the token matches the service system ID sent by the service system 120, the MAK public key in the token matches the MAK public key in the VCM 110, the current time is within the time window listed in the token, and/or the digital signature on the token is valid according to the public key of the management system 130. In one or more embodiments, each of these conditions is true before the VCM 110 executes the command, and if any one fails, the VCM 110 does not execute the command.

At 216, the VCM 110 connects to the management system 130 via the communication link 141. At 218, the VCM 110 creates a security credential request and a new security credential private/public key pair. At 220, the VCM 110 sends to the management system 130 the following information: the security credential request, the MAK public key of the VCM 110, a timestamp signed by the MAK private key of the VCM 110, and the service authorization token.

At 222, the management system 130 authenticates the security credential request received from the VCM 110. In one or more embodiments, the security credential request is authenticated if one or more of the following authentication checks are true: the signature on the timestamp is validated by the MAK public key, the timestamp is proximate to the current time, the MAK public key is registered to a security credential in the management system 130, the token signature is valid per the public key of the management system 130, the current time is between the token start time and the token end time, and the current time minus the time when the management system 130 last issued a security credential for the VCM 110 is greater than the minimum time between security credential replacement threshold. It should be appreciated that in one or more embodiments, each of the authentication checks is true before the management system 130 authenticates the request.

At 224, the management system 130 revokes the current security credential for the VCM 110. Then at 226, the management system 130 issues a new security credential for the VCM 110. At 228, the management system 130 sends the new security credential to the VCM 110 (e.g., via the communication link 141). At 230, the VCM 110 deletes its old security credential private/public key pair and, at 232, installs its new security credential.

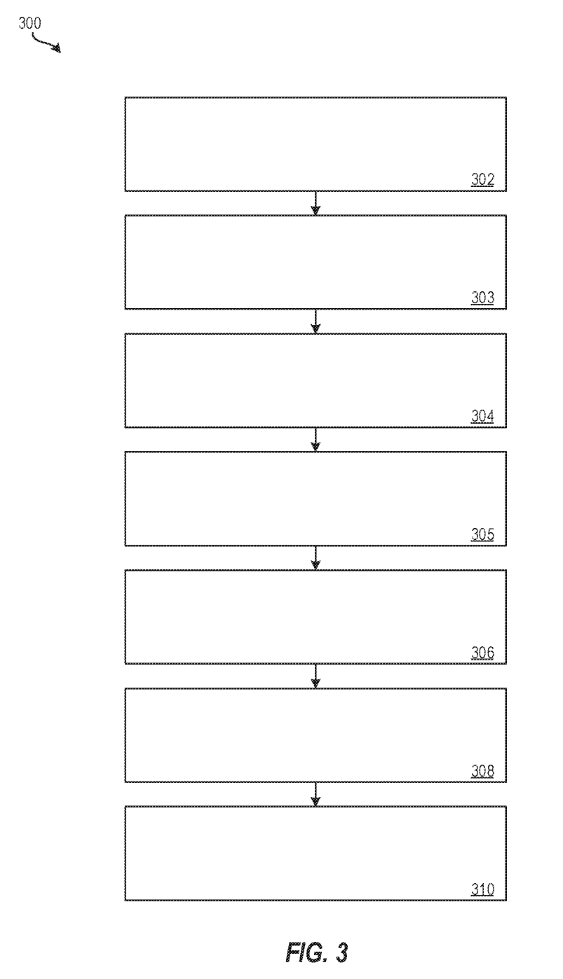

FIG. 3 depicts a flow diagram of a method 300 for replacing a security credential in a vehicle control module, according to aspects of the present disclosure. The method 300 can be implemented, for example, by the system 100 of FIG. 1, the processing system 400 of FIG. 4, or by another suitable processing system or device or combination thereof.

At block 302, the management system 130 authorizes, a service system to replace the security credential of the VCM 110. According to aspects of the present disclosure, the authorizing can include creating, by the service system 120, a request for service authorization; authenticating, by the management system 130, the request for service authorization; and issuing, by the management system 130, a service authorization token to the service system 120. The request for service authorization can include one or more of a service system identifier of the service system 120, a vehicle identifier of a vehicle 112 associated with the VCM 110, a vehicle control module identifier, a public key of the VCM 110, and a timestamp signed by the corresponding private key of the VCM 110. The service authorization token can include one or more of an identifier of the service system 120 that is authorized to perform the replacement, the public key of the VCM 110 whose security credential the service system 120 is authorized to replace, a time window (e.g., a start time and an end time) during which the service system 120 is authorized to perform the replacement, and a digital signature over the token created by a private key of the management system 130.

At block 303, the service system 120 initiates a replace security credential command to replace the security credential in the VCM 110. In examples, this includes the service system 120 sending to the VCM 110 the authorization token, a service system identifier, and a replace security credential command.

At block 304, the VCM 110 verifies the replace security credential command. According to aspects of the present disclosure, the VCM 110 verifies the request when the service system ID in the authorization token matches the service system ID sent by the service system 120, the MAK public key in the token matches the MAK public key in the VCM 110, the current time is within the time window listed in the token, and/or the digital signature on the token is valid according to the public key of the management system 130. It should be appreciated that in one or more embodiments, each of the authentication checks is true before the VCM 110 authenticates the command.

At block 305, the VCM 110 initiates a replace security credential request. In examples, this includes the VCM 110 sending to the management system 130 a replace security credential request, the VCM 110 MAK public key, a timestamp signed by the MAK private key, and the service authorization token.

At block 306, the management system 130 verifies the replace security credential request. According to aspects of the present disclosure, the management system 130 verifies the request when the timestamp signature is valid per the MAK public key, the MAK public key is registered to a security credential in the management system 130, the current time is proximate to the timestamp, the token signature is valid per the public key of the management system 130, the current time is between the token start time and the token end time, and the current time minus the time when the management system 130 last issued a security credential for the VCM 110 is greater than the minimum time between security credential replacement threshold. It should be appreciated that in one or more embodiments, each of the authentication checks is true before the management system 130 authenticates the request.

At block 308, the management system 130 creates a new security credential for the VCM 110. Before the new security credential is created, an old security credential can be revoked.

At block 310, the VCM 110 installs the new security credential. Installing the new security credential can include first deleting the old security credential.

Additional processes also may be included, and it should be understood that the processes depicted in FIG. 3 represent illustrations, and that other processes may be added or existing processes may be removed, modified, or rearranged without departing from the scope and spirit of the present disclosure.

It is understood in advance that the present disclosure is capable of being implemented in conjunction with any other type of computing environment now known or later developed. For example, FIG. 4 illustrates a block diagram of a processing system 400 for implementing the techniques described herein. In examples, processing system 400 has one or more central processing units (processors) 421a, 421b, 421c, etc. (collectively or generically referred to as processor(s) 421 and/or as processing device(s)). In aspects of the present disclosure, each processor 421 can include a reduced instruction set computer (RISC) microprocessor. Processors 421 are coupled to system memory (e.g., random access memory (RAM) 424) and various other components via a system bus 433. Read only memory (ROM) 422 is coupled to system bus 433 and can include a basic input/output system (BIOS), which controls certain basic functions of processing system 400.

Further illustrated are an input/output (I/O) adapter 427 and a network adapter 426 coupled to system bus 433. I/O adapter 427 can be a small computer system interface (SCSI) adapter that communicates with a hard disk 423 and/or other storage drive 425 or any other similar component. I/O adapter 427, hard disk 423, and storage device 425 are collectively referred to herein as mass storage 434. Operating system 440 for execution on processing system 400 can be stored in mass storage 434. A network adapter 426 interconnects system bus 433 with an outside network 436 enabling processing system 400 to communicate with other such systems.

A display (e.g., a display monitor) 435 is connected to system bus 433 by display adaptor 432, which can include a graphics adapter to improve the performance of graphics and general computation intensive applications and a video controller. In one aspect of the present disclosure, adapters 426, 427, and/or 432 can be connected to one or more I/O buses that are connected to system bus 433 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 433 via user interface adapter 428 and display adapter 432. A keyboard 429, mouse 430, and speaker 431 can be interconnected to system bus 433 via user interface adapter 428, which can include, for example, a Super I/O chip integrating multiple device adapters into a single integrated circuit.

In some aspects of the present disclosure, processing system 400 includes a graphics processing unit 437. Graphics processing unit 437 is a specialized electronic circuit designed to manipulate and alter memory to accelerate the creation of images in a frame buffer intended for output to a display. In general, graphics processing unit 437 is very efficient at manipulating computer graphics and image processing, and has a highly parallel structure that makes it more effective than general-purpose CPUs for algorithms where processing of large blocks of data is done in parallel.

Thus, as configured herein, processing system 400 includes processing capability in the form of processors 421, storage capability including system memory (e.g., RAM 424), and mass storage 434, input means such as keyboard 429 and mouse 430, and output capability including speaker 431 and display 435. In some aspects of the present disclosure, a portion of system memory (e.g., RAM 424) and mass storage 434 collectively store an operating system to coordinate the functions of the various components shown in processing system 400.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes can be made and equivalents can be substituted for elements thereof without departing from its scope. In addition, many modifications can be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method for replacing a security credential in a vehicle control module, the method comprising:
authorizing, by a processing device of a management system, a service system to replace the security credential of the vehicle control module;
initiating, by a processing device of the service system, a replace security credential command to replace the security credential in the vehicle control module;
verifying, by a processing device of the vehicle control module, the replace security credential command;
initiating, by the processing device of the vehicle control module, a replace security credential request;
verifying, by the processing device of the management system, the replace security credential request;
creating, by the processing device of the management system, a new security credential for the vehicle control module; and
installing, by the processing device of the vehicle control module, the new security credential.

2. The computer-implemented method of claim 1, wherein the authorizing comprises:
creating, by the processing device of the service system, a request for service authorization;
authenticating, by the processing device of the management system, the request for service authorization; and
issuing, by the processing device of the management system, a service authorization token to the service system.

3. The computer-implemented method of claim 2, wherein the request for service authorization comprises: a service system identifier of the service system, a vehicle identifier of a vehicle associated with the vehicle control module, a vehicle control module identifier, a public key of the vehicle control module, and a timestamp signed by the corresponding private key of the vehicle control module.

4. The computer-implemented method of claim 2, wherein the service authorization token comprises: an identifier of the service system that is authorized to perform the replacement, a public key of the vehicle control module whose security credential the service system is authorized to replace, a time window during which the service system is authorized to perform the replacement, and a digital signature over the authorization token created by a private key of the management system.

5. The computer-implemented method of claim 4, wherein the time window comprises a start time and an end time.

6. The computer-implemented method of claim 1, wherein the service system sending to the vehicle control module a replace security credential command to replace the security credential in the vehicle control module comprises the service system sending to the vehicle control module an authorization token, a service system identifier, and a replace security credential command.

7. The computer-implemented method of claim 1, wherein an old security credential is revoked prior to the new security credential being created.

8. A system comprising:
a memory comprising computer readable instructions; and
a processing device for executing the computer readable instructions for performing a method for replacing a security credential in a vehicle control module, the method comprising:
authorizing, by a management system, a service system to replace the security credential of the vehicle control module;
initiating, by the service system, a replace security credential command to replace the security credential in the vehicle control module;
verifying, by the vehicle control module, the replace security credential command;
initiating, by the vehicle control module, a replace security credential request;
verifying, by the management system, the replace security credential request;
creating, by the management system, a new security credential for the vehicle control module; and
installing, by the vehicle control module, the new security credential.

9. The system of claim 8, wherein the authorizing comprises:
creating, by the service system, a request for service authorization;
authenticating, by the management system, the request for service authorization; and
issuing, by the management system, a service authorization token to the service system.

10. The system of claim 9, wherein the request for service authorization comprises: a service system identifier of the service system, a vehicle identifier of a vehicle associated with the vehicle control module, a vehicle control module identifier, a public key of the vehicle control module, and a timestamp signed by the corresponding private key of the vehicle control module.

11. The system of claim 9, wherein the service authorization token comprises: an identifier of the service system that is authorized to perform the replacement, a public key of the vehicle control module whose security credential the service system is authorized to replace, a time window during which the service system is authorized to perform the replacement, and a digital signature over the authorization token created by a private key of the management system.

12. The system of claim 11, wherein the time window comprises a start time and an end time.

13. The system of claim 8, wherein the service system sending to the vehicle control module a replace security credential command to replace the security credential in the vehicle control module comprises the service system sending to the vehicle control module an authorization token, a service system identifier, and a replace security credential command.

14. The system of claim 8, wherein an old security credential is revoked prior to the new security credential being created.

15. The system of claim 8, wherein the vehicle control module sending to the management system a security credential request comprises the vehicle control module sending to the management system a security credential request command, a service authorization token from the service system, a public key of the vehicle control module, and a timestamp signed by a private key of the vehicle control module.

16. A computer program product comprising:
a computer readable storage medium having program instructions embodied therewith, the program instructions executable by one or more processing devices to cause the one or more processing devices to perform a method for replacing a security credential in a vehicle control module, the method comprising:
authorizing, by a management system, a service system to replace the security credential of the vehicle control module;
initiating, by the service system, a replace security credential command to replace the security credential in the vehicle control module;
verifying, by the vehicle control module, the replace security credential command;
initiating, by the vehicle control module, a replace security credential request;
verifying, by the management system, the replace security credential request;
creating, by the management system, a new security credential for the vehicle control module; and
installing, by the vehicle control module, the new security credential.
